(19) United States
(12) Patent Application Publication
(10) Pub. No.: US 2015/0345482 A1
(43) Pub. Date: Dec. 3, 2015

(54) GEOTHERMAL POWER PLANT FACILITY, METHOD FOR OPERATING A GEOTHERMAL POWER PLANT FACILITY, AND METHOD FOR INCREASING THE EFFICIENCY OF A GEOTHERMAL POWER PLANT FACILITY

(71) Applicant: Balcke-Dürr GmbH, Ratingen (DE)

(72) Inventors: Birger KLITZING, Krefeld (DE); Alexander WISSE, Sevenum (NL)

(21) Appl. No.: 14/724,624

(22) Filed: May 28, 2015

(30) Foreign Application Priority Data
May 30, 2014 (EP) 14 001 885.4

(51) Int. Cl. F03G 7/04; F01K 9/00; F01K 25/08

(52) U.S. Cl. CPC F03G 7/04; F01K 25/08; F01K 9/003

(57) ABSTRACT

The disclosure relates to a geothermal power plant facility, in particular utilizing the ORC method, wherein an and aspect thereof is that, for condensing the working fluid leaving a turbine, an air-cooled condenser and a water-cooled condenser are provided, which are connected in parallel to one another. A further aspect of some embodiments is a method for operating a geothermal power plant facility, wherein a step of the method is the separation of the working fluid to be condensed and the subsequent separate relay of the partial volume flows of the working fluid to an air-cooled condenser, on the one hand, and to a water-cooled condenser, on the other hand. Finally, a further aspect of some embodiments is a method for retrofitting a conventional geothermal power plant facility, additionally incorporating a water-cooled condenser which is connected in parallel to an air-cooled condenser.

### CROSS-REFERENCE TO RELATED APPLICATIONS

This application claims priority to European Patent Application No. 14001885.4, filed on May 30, 2014, the disclosure of which is incorporated herein by reference in its entirety.

### TECHNICAL FIELD

The disclosure relates to a geothermal power plant facility, a method for operating a geothermal power plant facility, and a method for increasing the efficiency of a geothermal power plant facility operating according to the ORC principle.

### BACKGROUND

There is an increasing demand for also using so-called renewable energy sources to a larger extent for obtaining energy. One possibility which is widespread in this context is the use of geothermal heat. Such facilities are referred to hereafter as geothermal power plant facilities. Such geothermal power plant facilities typically make use of the so-called steam turbine process (“Rankine cycle”) principle for power generation. The elements in this case are a vaporization unit for obtaining steam by means of geothermal energy, a turbine, a condenser, and a feed pump. The generated steam is used to drive the turbine, which in turn drives a generator for generating electrical energy, for example. The steam is subsequently condensed and supplied to the vaporizer again via the feed pump, so that overall a cycle of a known type results. In particular if geothermal heat is used as an energy source for the vaporization, the so-called organic Rankine cycle (ORC) is frequently used, the difference of which is that the working fluid, instead of water steam, is an organic liquid having a lower vaporization temperature in comparison to water, such as in particular n-pentane. A generic geothermal power plant facility is therefore distinguished in that it comprises a geothermal energy supply source, a vaporizer for a working fluid, in which the working fluid is vaporized with the aid of geothermal energy, a line system is provided in which the working fluid is guided, a turbine is provided which is driven with the aid of the vaporized working fluid, an air-cooled condenser is arranged downstream of the turbine, in which the working fluid is condensed after the turbine as regarded in the conveyance direction, and a pump, using which the condensed working fluid is returned to the vaporizer to obtain a cycle.

Geothermal energy refers in this case to heat stored in the Earth's crust, which is conveyed by means of water or the like, in particular brine, for example, to the surface and is thus available to the geothermal power plant facility for obtaining energy. A corresponding conveyance unit and the further required means for making the geothermal energy available are referred to in the present case in general as a “supply source”. The vaporizer is in general a unit in which the working fluid is vaporized with the aid of geothermal energy. The working fluid refers to the fluid which drives the turbine. Line system refers to the entirety of lines for guiding the working fluid between the individual components, such as in particular vaporizer, turbine, condenser, and pump.

An element of a generic geothermal power plant facility is an air-cooled condenser, which is arranged downstream of the turbine. The working fluid thus passes the air-cooled condenser after the turbine as regarded in the conveyance direction of the working fluid. The central task of the condenser is to condense the working fluid. The heat-absorbing medium of the air-cooled condenser is air, in particular ambient air, which is guided past corresponding heat exchanger elements of the condenser by means of ventilators, for example. A heat exchange takes place between the working fluid and the ambient air, whereby condensation of the working fluid is achieved. The pump subsequently conveys the condensed working fluid back to the vaporizer, so that the working fluid overall passes through an essentially closed circuit. The use of air-cooled condensers has proven itself in particular in regions having water scarcity, since they do not require water for cooling purposes.

As an alternative to using an air-cooled condenser, furthermore, using a water-cooled condenser is known. Water-cooled condensers are distinguished in that the heat-absorbing medium is water. The use of water cooling is advantageous in that the overall efficiency of the geothermal power plant facility can be increased in this way, since the vaporized working fluid can be cooled down to lower temperatures. This applies in particular if a wet cooling tower is used for providing the cold water. However, it is disadvantageous that a wet cooling tower typically has very high water consumption, which cannot be covered or can only be covered with high expenditure because of the geographical location of the geothermal power plant facility.

The condensers used are typically surface condensers, in particular in the form of tube bundle heat exchangers or plate heat exchangers.

### SUMMARY

An aspect of this disclosure is to specify a geothermal power plant facility, which on the one hand has improved efficiency compared with conventional facilities and at the same time can also be used cost-effectively in regions having little water availability.

This aspect may be achieved with a geothermal power plant facility, a method for operating a geothermal power plant facility, and a method for increasing the efficiency of a geothermal power plant facility, which operates in particular according to the ORC principle, according to the independent claims. Preferred refinements are specified in the dependent claims. For carrying out the method, use is made in particular of a geothermal power plant facility according to the disclosure.

A basic idea of this disclosure is to provide an additional water-cooled condenser as a supplement to the air-cooled condenser. The geothermal power plant facility therefore has two condensers, which transfer the heat to different media. It is of central significance here that the additional water-cooled condenser is not arranged in series but in parallel to the air-cooled condenser. This specific arrangement enables the working fluid exiting from the generator to proportionally flow through the air-cooled condenser and the water-cooled condenser in parallel. Bypassing the air-cooled condenser, a part of the working fluid is thus guided to the water-cooled condenser for condensation downstream of the turbine. Parallel to this, bypassing the water-cooled condenser, the other part of the working fluid flows through the air-cooled condenser. The working fluid is thus divided into two partial flows before flowing into the condensers, which pass either exclusively the air-cooled condenser or exclusively the water-cooled condenser for condensation. The partial flows, or the corresponding condensates, of the working fluid are guided back together only downstream of the two condensers and are subsequently returned to the vaporizer via the pump. It is an aspect of some embodiments that, on the one hand, two condensers having different cooling media (air and water) are used and, on the other hand, the condensation of the working fluid is performed proportionally either only by the water-cooled condenser or only by the air-cooled condenser. The two condensers provided according to the disclosure are therefore completely and exclusively connected in parallel to one another. This basic arrangement has the result that, due to the supplementary use of a water-cooled condenser, the overall cooling capacity for the working fluid can be increased. On the other hand, the total water consumption for cooling purposes is comparatively low, since the air-cooled condenser is used in addition. This overall arrangement enables a high-grade adaptation of the overall cooling capacity to the respectively existing conditions, whether it is with respect to external temperatures, present water availability, and/or power plant utilization, for example.

Ideally, a line branching point is provided in the line system downstream of the turbine, said line branching point having a first outlet leading to the air-cooled condenser, and having a second outlet leading to the water-cooled condenser. The working fluid is thus discharged centrally from the turbine and is only subsequently divided by the line branching point for the divided relay to one of the two condensers in each case. As described in more detail below, this facilitates in particular the retrofitting of existing generic geothermal power plant facilities with, for example, the additional water-cooled condenser.

In addition, the line branching point can in particular serve as a starting point for varying or controlling the ratio of the partial flows of the working fluid conducted to the air-cooled and the water-cooled condensers with respect to one another, for example with regard to the volume flow. Preferably, the line branching point therefore comprises at least one valve via which the ratio of the partial volume flows of the working fluid flowing out of the two outlets of the line branching point in relation to one another is variable. In this manner, for example, an existing temporary water scarcity can be reacted to, for example, in such a manner that the proportion of the working fluid conducted to the air-cooled condenser is increased and accordingly the proportion of the working fluid conducted to the water-cooled condenser is reduced. It is particularly preferable in this embodiment if the line branching point directly also structurally comprises the valve. The line branching point and the valve in this case represent a shared structural unit having the function of a continuously adjustable valve having one inlet and two outlets. A particularly compact embodiment can thus be obtained at this point. Additionally or alternatively, provision may be made for valves or shutoff devices that are respectively provided downstream of the line branching point to the air-cooled condenser and/or to the water-cooled condenser for adjusting the respective volume flow conducted to the two condensers. The control of the allocation of the volume flows can furthermore preferably be performed such that one of the two condensers, preferably the water-cooled condenser, is utilized at its maximum capacity and the air-cooled condenser handles the remaining working fluid to be condensed.

Further, it is basically possible to guide the condensate originating from the air-cooled condenser and the condensate originating from the water-cooled condenser individually in each case to the vaporizer. However, it is also preferable here if a line unification point is provided downstream of the two condensers in the line system. The line unification point is distinguished in that the condensates from the two condensers are unified by it and are subsequently conducted via the line system in a shared line to the pump. Only one pump is then accordingly required here. This embodiment is also particularly suitable for retrofitting purposes.

The geothermal power plant facility according to this disclosure can furthermore comprise further elements in particular with reference to the working fluid circuit, which elements can be integrated into the overall system in addition to the above-described basic structure. This relates, for example, to the preferred arrangement of a heat exchanger, in particular, as regarded in the flow direction of the working fluid, between the turbine and the air-cooled and/or the water-cooled condenser. With the aid of this heat exchanger, it is possible to extract heat from the working fluid, which can be used for further processes, for example for preheating or the like.

Of course, the geothermal power plant facility according to this disclosure can also have more than one turbine. In this refinement preferably an air-cooled condenser and a water-cooled condenser arranged in parallel thereto are respectively provided for each turbine in the above-described manner. Accordingly, one air-cooled and one water-cooled condenser are available in each case for each turbine.

Basically, the full spectrum of the known alternatives can be used for the water supply of the water-cooled condenser. However, it has proven to be particularly preferable when the cooling water of the water-cooled condenser is guided in a cooling water circuit. The water demand and consumption of the geothermal power plant facility according to this disclosure can thus be substantially reduced, so that the arrangement can also be used in regions having few water resources.

A cooling water temperature that is as low as possible is effective water cooling. This is achieved particularly effectively if the water cooling of the cooling water circuit is performed with the aid of a wet cooling tower. Such wet cooling towers are basically known and are described for example in EP 0 162 993 B1, to which reference is hereby made merely as an example.

In order to increase the independence of a geothermal power plant facility according to the disclosure from a continuous external cooling water supply, the cooling water circuit preferably comprises a water reservoir in which water can be kept available for cooling purposes. The water reservoir thus constitutes a type of supply buffer for the cooling water. It has been found in practical application that the storage capacity of the water reservoir is preferably dimensioned such that it is to accommodate the maximum cooling water consumption in the range of at least one hour up to at most 20 hours. The maximum water consumption is strongly dependent on the overall design of the respective geothermal power plant facility, in particular also on the local conditions, a typical average value here being, for example, 50 m³/hour. In particular with regard to temporary failure of an external cooling water supply and for covering temporary peak consumption (for example in the midday hours), such a dimensioning of the storage capacity has proven itself. In this manner, most failure times can be bridged and the overall size of the water reservoir will then generally not yet exceed a cost-effective size.

Here, and in particular for the case in which multiple turbines are driven and one water-cooled and one air-cooled condenser are available for each turbine, it is preferred if a shared cooling water circuit having corresponding branching points is used to supply the water-cooled condensers. It is thus particularly preferred if one wet cooling tower supplies the water-cooled condensers of multiple turbines with cooling water.

The supply of the geothermal power plant facility according to the disclosure can also be varied in many ways. For example, in particular brine, condensate and/or treated water may also be used to compensate for water losses of cooling water in the cooling water circuit.

The geothermal power plant facility according to the disclosure is preferably an ORC facility. Such facilities are distinguished in that they are based on the so-called organic Rankine cycle, in which organic fluids, in particular organic hydrocarbons, very particularly n-pentane or halogenated hydrocarbons, are used as the working fluid. The advantage of these working fluids is their lower vaporization temperature, whereby more effective utilization of geothermal energy is possible.

A further aspect of the disclosure resides in a method for operating a geothermal power plant facility. The geothermal power plant facility is preferably implemented in this case according to the above descriptions. The method according to the disclosure firstly comprises the vaporization of a working fluid, in particular an organic working fluid, in a vaporizer with the aid of geothermal energy. With the aid of the vaporized working fluid, the operation of a turbine is performed in a next step, to which a generator is typically connected for generating electrical power. In some embodiments, the separation of the working fluid into a partial fluid flow conducted to an air-cooled condenser and a partial fluid flow conducted to a water-cooled condenser is performed downstream of the turbine. The working fluid is therefore no longer jointly cooled in one condenser after exiting from the turbine, but rather proportionally in each case in an air-cooled condenser or in a water-cooled condenser. The working fluid is therefore cooled in parallel in two different condensers and does not pass through both condensers successively for this purpose. The two condensed partial fluid flows are preferably guided together again downstream of the two condensers before passing a pump and are subsequently returned jointly to the vaporizer. A circuit is thus closed, an ORC method being preferably used here, in particular using an organic working fluid.

The cooling of the water-cooled condenser is ideally performed by means of water circulated in a cooling water circuit having a wet cooling tower. The cooling water demand for carrying out the method according to the disclosure can be reduced substantially by utilizing a cooling water circuit. A wet cooling tower is distinguished by its high cooling efficiency. However, an external water supply nonetheless frequently cannot be dispensed with when a cooling water circuit is used. To reduce the dependence of the method according to the disclosure on a continuous external water supply still further, temporary storage of cooling water in a water tank downstream of the wet cooling tower is preferably performed in operation of the cooling water circuit. A predefined quantity of cooling water is thus kept available by the temporary storage, so that this cooling water reserve can be used to compensate for supply shortages of an external water supply. The preferred storage capacity is optimally ascertained on the basis of the maximum water consumption per hour, the storage capacity preferably being the maximum consumption in the range of from one to 20 hours.

The method according to the disclosure can be used in a particularly advantageous manner if the ratio of the partial fluid flows to the air-cooled and the water-cooled condenser is controlled during operation of the geothermal power plant facility. The respective proportion of the working fluid which is conducted to the air-cooled condenser or to the water-cooled condenser is thus varied in this preferred refinement of the method according to the disclosure. In this manner, changing operating conditions can be reacted to particularly efficiently. In particular, the closed-loop control of the ratio is performed as a function of, for example, the external temperature of the ambient air and/or the temperature of the working fluid on the intake side to the vaporizer and/or the fill level of a water tank for cooling water. In particular the latter refinement of the method according to the disclosure is particularly relevant when the fill level of the water tank for cooling water is very low. It is then possible, for example, to switch over to an increase of the working fluid supplied to the air-cooled condenser in steps, for example to prevent complete emptying of the water tank.

A further basic idea of the disclosure finally also resides in a method for increasing the efficiency of a geothermal power plant facility operating according to the ORC principle with the aid of suitable retrofitting. The starting point is here in particular a generic geothermal power plant facility having an air-cooled condenser for condensing a working fluid downstream of a generator. For the construction of a generic geothermal power plant facility, reference is made to the above statements. The above-described refinement according to the disclosure of the geothermal power plant facility is very well suitable for the retrofitting of existing geothermal power plant facilities. For incorporating the additional water-cooled condenser, it preferable to firstly introduce a line branching point downstream of the generator before the air-cooled condenser into an existing line for separating the working fluid flow into two partial fluid flows. It is thus possible to branch off a volume proportion from the fluid flow of the working fluid exiting from the generator and to supply it to the water-cooled condenser to be retrofitted. Provision is further made for the introduction of a line unification point into the existing line system upstream of a pump, which enables the separated partial fluid flows of the working fluid to be guided together again after the air-cooled condenser and the water-cooled condenser as regarded in the flow direction. Finally, a water-cooled condenser is connected between the line branching point and the line unification point in parallel to the air-cooled condenser. In this manner, if the generic geothermal power plant facility already comprises a circuit using a working fluid with an air-cooled condenser, the supplementary water-cooled condenser to be used in parallel can be retrofitted.

In a preferred refinement of the method according to this disclosure, provision is further made for connection of the water-cooled condenser to a cooling water circuit having a wet cooling tower in particular. In this manner, the above-described advantages of a cooling water circuit for cooling the water-cooled condenser may be obtained.

Of course, it is also possible to retrofit an existing geothermal power plant facility having an already existing water-cooled condenser successively with an air-cooled condenser. In this case, an air-cooled condenser is connected according to the above statements regarding the water-cooled condenser.

The various embodiments are described in greater detail below with reference to the exemplary embodiments shown in the figures. In the schematic drawings:

### BRIEF DESCRIPTION OF THE DRAWINGS

FIG. 1 shows a structural outline of an embodiment of a geothermal power plant facility according to an embodiment;

FIG. 2 shows a structural outline of an embodiment of a second geothermal power plant facility according to an embodiment;

FIG. 3 shows a flow chart for carrying out the method according to an embodiment for operating a geothermal power plant facility; and

FIG. 4 shows a flow chart for retrofitting an existing geothermal power plant facility.

### DETAILED DESCRIPTION

Like components are indicated by like reference numerals in the figures, wherein not every repeating component is designated separately.

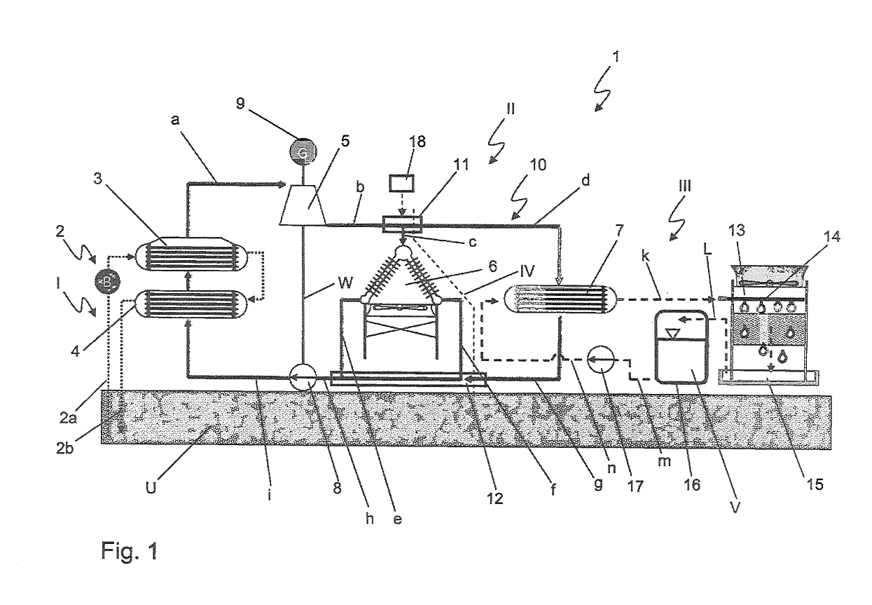

FIG. 1 shows the structure of an exemplary embodiment of a geothermal power plant facility 1 according to the disclosure. Some of the elements of the geothermal power plant 1 are firstly a geothermal energy supply source 2 comprising a supply line 2a and a return line 2b. With the aid of the supply source 2, geothermal energy can be conveyed from the interior of the earth, for example in the form of heated brine B from the soil or subsoil U. In the present exemplary embodiment, the heated brine is firstly supplied to a vaporizer 3 and subsequently to an optional preheater 4 and is returned into the subsoil. A heat supply circuit I is thus obtained. A further preferable element of the geothermal power plant facility 1 is a working fluid circuit II. The working fluid circuit II is implemented to carry out an ORC method and comprises, in addition to the vaporizer 3 and the optional preheater 4, in the conveyance direction of the working fluid, a turbine 5, an air-cooled condenser 6, and also a water-cooled condenser 7 as well as a conveyor pump 8. A generator 9 for power generation is driven by the turbine 5. A drive connection W is simultaneously present between the turbine 5 and the conveyor pump 8, via which the pump drive of the conveyor pump 8 is ensured. This connection can be of a mechanical or electrical nature. Between these components, the organic working fluid is moved in a cycle in a line system and firstly passes, after the vaporization in the vaporizer 3, the turbine 5 via the line section a. Subsequently, the line section b conducts the working fluid to a line branching point 11, by which a first partial flow of the working fluid is supplied via the line section c to the air-cooled condenser 6 and another, second partial fluid flow is supplied via the line section d to the water-cooled condenser 7. The condensed working fluid from the air-cooled condenser 6 is conducted via the line sections e and f into a line unification point 12, into which the condensate from the water-cooled condenser 7 is also discharged via the line section g. The unified condensates of the working fluid leave the line unification point 12 via the line section h and are supplied there to the conveyor pump, which supplies the working fluid via the line section i firstly to the preheater 4 and subsequently to the vaporizer 3 again. The entirety of the line sections a to i in this case designates the line system 10, in which the working fluid is conducted between the individual functional units, such as for example the vaporizer, the conveyor pump, the turbine, and the two condensers.

In this basic structure that the working fluid is supplied downstream of the line branching point 11 proportionally either exclusively to the air-cooled condenser 6 or, in parallel thereto, to the water-cooled condenser 7 via the line sections c and d. The volume flow of the working fluid coming from the turbine is therefore split into two partial flows, which are spatially and functionally separated and at the same time are subjected to the condensation process essentially simultaneously to each other. A parallel arrangement of the air-cooled condenser 6 and the water-cooled condenser 7 thus results. A successive passage of both condensers 6 and 7 by the working fluid is precluded and also is not intended. Via the line unification point 12, the condensate flows of the working fluid are unified again downstream of the air-cooled condenser 6 and the water-cooled condenser 7 and are jointly supplied via the conveyor pump 8 to the vaporization process again. The line unification point 12 therefore has a total of three fluid inlets, two of which being assigned to the air-cooled condenser 6 (tube sections e and f) and one to the water-cooled condenser 7 (line section g).

Both the air-cooled condenser 6 and also the water-cooled condenser 7 are implemented as surface condensers. Mixing of the cooling medium with the working fluid therefore does not take place. The cooling medium of the air-cooled condenser 6 is external ambient air and the cooling medium of the water-cooled condenser 7 is cooling water. The latter is circulated in the present exemplary embodiment inside a cooling water circuit III. The basic elements of the cooling water circuit are a wet cooling tower comprising a distribution unit 14, a collecting basin 15, a water reservoir 16 (wherein the water reservoir 16 can also be a direct part of the collecting basin 15), a cooling water pump 17, and the water-cooled condenser 7. The cooling water is conducted in this case via a line system having the line sections k (between the water-cooled condenser 7 and the wet cooling tower 13), L (between the collecting basin 15 and water reservoir 16), m (between the water reservoir 16 and the cooling water pump 17), and n (between the cooling water pump 17 and the water-cooled condenser 7). The water reservoir 16 is used for the present basic construction, the storage volume V of which ideally corresponds to the range “1 hour×VBₘₐₓ<=V<=20 hours×VBₘₐₓ”. The maximum water consumption VBₘₐₓ corresponds in this case to the maximum available quantity of water in cubic meters per hour, which is specified by the operator. This value is specific to the facility and is typically specified by the purchaser of the geothermal power plant facility 1. A typical value is, for example, 50 m³/hour.

In the present exemplary embodiment, the geothermal power plant facility 1 further comprises a control unit 18, which controls a valve, which is not shown in greater detail, inside the line branching point 11. With the aid of the control unit 18, the proportion of the working fluid (volume flow) conducted to the air-cooled condenser 6 and to the water-cooled condenser 7 can therefore be varied via the valve. Control variables which can be considered by the control unit 18 are, for example, the temperature of the external ambient air, the fill level of the water reservoir 16, the temperature of the working fluid in the line section b and/or in the line section h, etc.

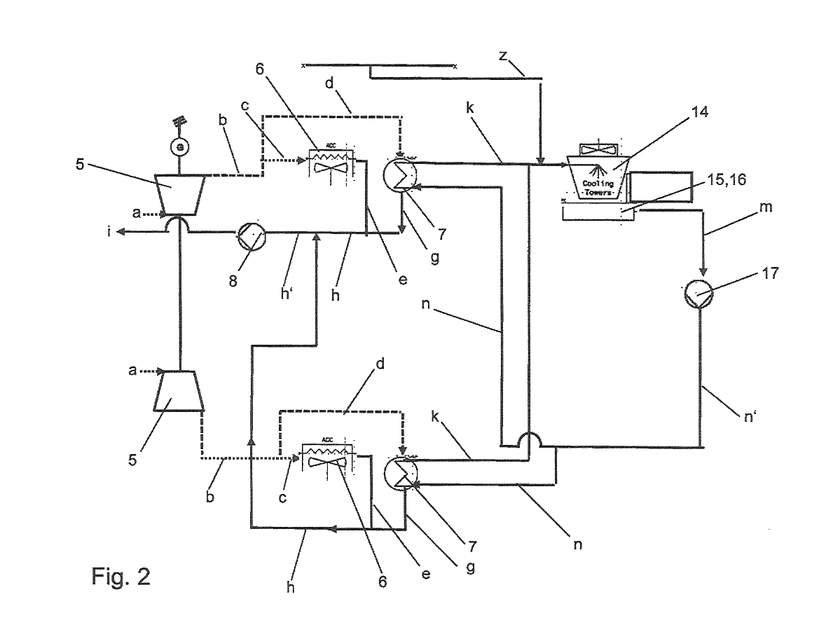

FIG. 2 relates to a variant of the exemplary embodiment of FIG. 1, wherein only the differences are discussed below while otherwise reference is made to the above statements. The facility is shown starting at the line section a and up to the line section i in the ORC circuit, so that the circuit I is not indicated in FIG. 2 for reasons of comprehensibility.

The geothermal power plant facility 1 shown in FIG. 2 comprises a total of two turbines 5, which jointly drive a generator G. The working fluid flowing out of the two turbines 5 is respectively cooled, in cooling circuits which are separate from one another, in an air-cooled and in a water-cooled condenser 6, 8 for each turbine 5. Subsequently, the condensates of both circuits are guided together in the line section h′ and centrally again subjected to the vaporization procedure using geothermal energy. Each turbine 5 therefore has its own condensers 6 and 7.

A further special feature is that the cooling water circuit of the two water-cooled condensers 7 runs together in a shared wet cooling tower 14. Both condensers are therefore jointly supplied by a cooling water circuit with cooling water via the line section n′, which discharges in a corresponding line branching point into the line sections n to the two water-cooled condensers 7. Furthermore, a supply line is indicated with the line section z in FIG. 2, using which water losses within the cooling water circuit can be compensated for. For this purpose, for example, brine, condensate, and/or treated water can be used. The quantity of water available for this supply finally specifies the value VBₘₐₓ.

In the wet cooling tower 14 shown in FIG. 2, the collecting basin 15 is furthermore implemented sufficiently large that it simultaneously functions as a water reservoir 16. A water reservoir 16 which is separate and spatially separated from the collecting basin 15 is accordingly no longer needed.

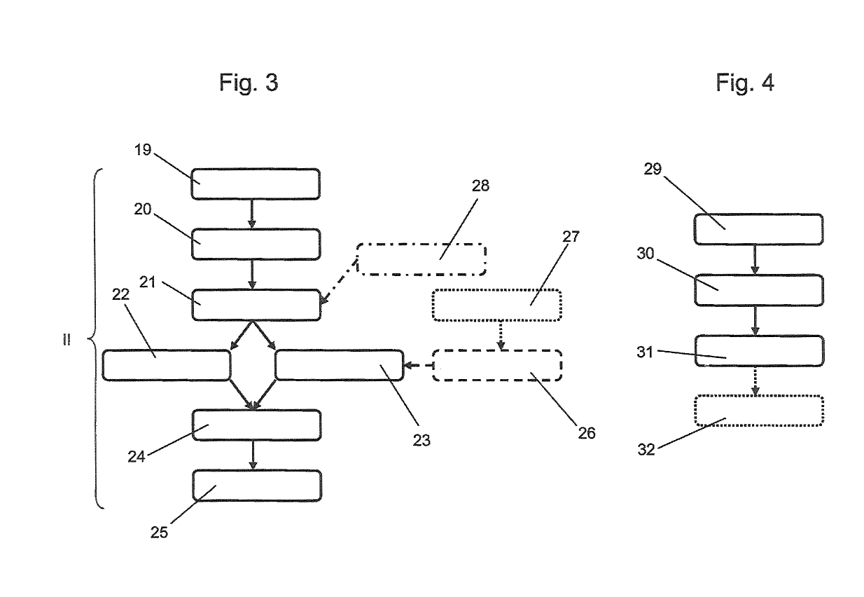

FIG. 3 illustrates the method sequence for operating the geothermal power plant facility 1. The method steps are in this case firstly the vaporization of the working fluid in the vaporizer 3 in step 19 with the aid of geothermal energy. Subsequently, the operation 20 of the turbine 5 is performed with the aid of the working fluid vaporized in step 19. After the working fluid exits from the turbine 5 or downstream of the turbine 5, in step 21, a separation of the working fluid is performed into a partial fluid flow conducted to the air-cooled condenser 6 and a partial fluid flow conducted to the water-cooled condenser 7. The two partial fluid flows are now condensed in parallel to one another in steps 22 (in the air-cooled condenser 6) and 23 (in the water-cooled condenser 7). However, the condensation is performed spatially and functionally separated from one another using the two condensers 6 and 7, which have cooling media that differ from one another, specifically water and air. The condensates of both condensed partial fluid flows are unified again in step 24 downstream of the two condensers 6 and 7 and are subsequently jointly supplied to the vaporizer 3 again in step 25. The cycle is thus closed.

Steps 26, 27, and 28 indicate preferred refinements of this method. Thus, in particular the water-cooled condenser 7 in step 23 can be integrated in a cooling water circuit III according to the above statements, in particular comprising a wet cooling tower 13, wherein optionally the transitional temporary storage 27 of cooling water in a water tank 16 can furthermore be provided here. The operational reliability of the method according to the disclosure can be substantially improved in this manner.

A control of the separation 21 of the working fluid into the two partial fluid flows is provided as a further preferred refinement alternative in step 28. For this purpose, for example, the valve in the line branching point 11 is controlled and thus the volume flow proportion of the partial fluid flow conducted to the air-cooled condenser 6 is varied in relation to the partial fluid flow conducted to the water-cooled condenser 7. This step can be part of a closed-loop control process, which can be a corresponding control as a function of closed-loop control variables such as, for example, the external temperature of the ambient air and further variables.

The above-described geothermal power plant facility 1 can also be obtained by a method for retrofitting a conventional geothermal power plant facility 1, which only provides an air-cooled condenser 6 for condensing the working fluid, for example. Steps 29, 30, and 31, which are used for the retrofitting, are specified in greater detail in FIG. 4. An introduction 29 of the line branching point 11 downstream of the turbine 5 before the already existing air-cooled condenser 6 is followed in step 30 by an introduction of the line unification point 12 upstream of the pump 8, so that thus a total of two connections is obtained between the line branching point 11 and the line unification point 12 for the additional water-cooled condenser 7 to be connected in step 31. A parallel connection of the air-cooled condenser 6 to the water-cooled condenser 7 is thus achieved.

In the retrofitting process, according to step 32, the connection of the water-cooled condenser 7 to the cooling water circuit III, in particular comprising the wet cooling tower 13, can furthermore optionally be performed.

The retrofitting operation or the retrofitting interfaces are illustrated in greater detail in FIG. 1 with dashed line IV. According to the method shown in FIG. 3, the region to the right of dashed line IV including the line branching point 11 and the line unification point 12 is therefore to be retrofitted.

An alternative to this retrofitting method, which is not described in greater detail, can also consist, of course, in the air-cooled condenser 6 being retrofitted in addition to a water-cooled condenser 7.

1. A geothermal power plant facility comprising:
a geothermal energy supply source;
a vaporizer for a working fluid, in which the working fluid is vaporized with the aid of geothermal energy;
a line system, in which the working fluid is guided;
a turbine, which is driven with the aid of the vaporized working fluid;
an air-cooled condenser downstream of the turbine, in which working fluid is condensed; and
a pump using which condensed working fluid is returned to the vaporizer, wherein a water-cooled condenser is provided which is connected in parallel to the air-cooled condenser, and that a part of the working fluid is guided to the water-cooled condenser for condensation downstream of the turbine while bypassing the air-cooled condenser, and that the condensates of the working fluid from the air-cooled condenser and from the water-cooled condenser are guided together downstream of the two condensers and are subsequently returned via the pump to the vaporizer.

2. The geothermal power plant facility according to claim 1, further comprising a line branching point having a first outlet leading to the air-cooled condenser and having a second outlet leading to the water-cooled condenser is provided in the line system downstream of the turbine.

3. The geothermal power plant facility according to claim 2, wherein the line branching point comprises a valve via which the ratio of the two volume flows flowing out of the two outlets in relation to one another can be controlled.

4. The geothermal power plant facility according to claim 1, wherein downstream of the two condensers in the line system, a line unification point is provided via which the condensates from the two condensers are unified and subsequently conducted via the line system jointly to the pump.

5. The geothermal power plant facility according to claim 1, further comprising a heat exchanger, using which thermal energy can be withdrawn from the working fluid, is arranged, as regarded in the flow direction of the working fluid, between the turbine and the air-cooled and/or the water-cooled condenser.

6. The geothermal power plant facility according to claim 1, wherein the cooling water of the water-cooled condenser is guided in a cooling water circuit.

7. The geothermal power plant facility according to claim 6, wherein the cooling water circuit comprises a wet cooling tower.

8. The geothermal power plant facility according to claim 6, wherein the cooling water circuit comprises a water reservoir, the storage capacity of which is designed such that it is to accommodate the maximum cooling water consumption in the range of at least 1 hour to at most 20 hours.

9. The geothermal power plant facility according to claim 6, wherein the cooling water circuit comprises a water reservoir, the storage capacity of which is designed such that it is to accommodate the maximum cooling water consumption in the range of at least 2 hours to at most 10 hours.

10. The geothermal power plant facility according to claim 1, wherein the geothermal power plant facility is an ORC facility, wherein the working fluid is in particular an organic hydrocarbon.

11. The geothermal power plant facility according to claim 10, wherein the geothermal power plant facility is an ORC facility, wherein the working fluid is n-pentane or a halogenated hydrocarbon.

12. A method for operating a geothermal power plant facility, comprising:
vaporizing a working fluid in a vaporizer with the aid of geothermal energy;
operating a turbine with the aid of the vaporized working fluid;
downstream of the turbine, separating the working fluid into a partial fluid flow conducted to an air-cooled condenser and a partial fluid flow conducted to a water-cooled condenser;
condensing the two partial fluid flows in parallel to one another in the air-cooled condenser and in the water-cooled condenser;
unifying the two partial fluid flows downstream of the two condensers; and
returning the working fluid to the vaporizer.

13. The method according to claim 12, wherein the cooling water circuit having a wet cooling tower is used for cooling the water-cooled condenser.

14. The method according to claim 13, wherein the operation of the cooling water circuit comprises a temporary storage of cooling water in a water tank downstream of the wet cooling tower.

15. The method according to claim 12, wherein in operation of the geothermal power plant facility, a closed-loop control of the ratio of the partial fluid flows to the air-cooled and to the water-cooled condensers is performed.

16. The method according to claim 15, wherein closed-loop control is performed as a function of the external temperature and/or the temperature of the working fluid on the inlet side of the vaporizer and/or the fill level of a water tank for cooling water.

17. The method according to claim 12, further comprising:
introducing a line branching point downstream of the generator before the air-cooled condenser to separate the working fluid flow into two partial fluid flows;
introducing a line unification point upstream of a pump using which the working fluid is conducted to a vaporizer, to unify the two partial fluid flows; and
connecting a water-cooled condenser between the line branching point and the line unification point in parallel to the air-cooled condenser.

18. The method according to claim 17, further comprising:
a connection of the water-cooled condenser to a cooling water circuit having a wet cooling tower is performed.

19. A method for increasing the efficiency of a geothermal power plant facility operating according to the ORC principal with an air cooled condenser for condensing a working fluid downstream of a generator, the geothermal power plant facility comprising:
a geothermal energy supply source;
a vaporizer for a working fluid, in which the working fluid is vaporized with the aid of geothermal energy;
a line system, in which the working fluid is guided;
a turbine, which is driven with the aid of the vaporized working fluid;
an air-cooled condenser downstream of the turbine, in which working fluid is condensed; and
a pump using which condensed working fluid is returned to the vaporizer, wherein a water-cooled condenser is provided which is connected in parallel to the air-cooled condenser, and that a part of the working fluid is guided to the water-cooled condenser for condensation downstream of the turbine while bypassing the air-cooled condenser, and that the condensates of the working fluid from the air-cooled condenser and from the water-cooled condenser are guided together downstream of the two condensers and are subsequently returned via the pump to the vaporizer;
the method comprising:
vaporizing a working fluid in a vaporizer with the aid of geothermal energy;
operating a turbine with the aid of the vaporized working fluid;
downstream of the turbine, separating the working fluid into a partial fluid flow conducted to an air-cooled condenser and a partial fluid flow conducted to a water-cooled condenser;
condensing the two partial fluid flows in parallel to one another in the air-cooled condenser and in the water-cooled condenser;
unifying the two partial fluid flows downstream of the two condensers; and
returning the working fluid to the vaporizer;
introducing a line branching point downstream of the generator before the air-cooled condenser to separate the working fluid flow into two partial fluid flows;
introducing a line unification point upstream of a pump using which the working fluid is conducted to a vaporizer, to unify the two partial fluid flows; and
connecting a water-cooled condenser between the line branching point and the line unification point in parallel to the air-cooled condenser.
